(19) United States
(12) Patent Application Publication
(10) Pub. No.: US 2026/0166895 A1
(43) Pub. Date: Jun. 18, 2026

(54) PRINTER, PRINTER CONTROL METHOD, AND PROGRAM

(71) Applicant: SATO HOLDINGS KABUSHIKI KAISHA, Tokyo (JP)

(72) Inventor: Kota WAKABAYASHI, Minato-ku (JP)

(73) Assignee: SATO HOLDINGS KABUSHIKI KAISHA, Tokyo (JP)

(21) Appl. No.: 18/710,006

(22) PCT Filed: Oct. 24, 2022
(86) PCT No.: PCT/JP2022/039555

§ 371 Date: May 14, 2024

(30) Foreign Application Priority Data
Nov. 30, 2021 (JP) 2021-194630

(51) Int. Cl. B41J 11/46; B41J 2/325; B41J 3/407; B41J 11/00

(52) U.S. Cl. CPC B41J 11/46; B41J 3/4075; B41J 11/0095; B41J 2/325

(57) ABSTRACT

A printer performs printing on a label by a printing unit while conveying a label continuous body in which labels are arranged at a predetermined spacing, measures, by a second detection unit, an arrangement length of the label on which the printing is performed, sets a reference print start position of the label upstream of the printing unit based on the measured arrangement length, and corrects the reference print start position using the arrangement length and an inter-unit distance between the printing unit and a first detection unit.

### TECHNICAL FIELD

The present invention relates to a printer, a printer control method, and a program.

### BACKGROUND ART

There is a printer that prints on a label continuous body in which labels are releasably attached to a long liner sheet. In such a printer, each of the labels is detected by a sensor for printing alignment disposed upstream of a printing unit, and the label and the printing unit are aligned.

In the above printer, when printing is first performed on a newly set label continuous body, the label continuous body must be conveyed until a label can be detected by the sensor for printing alignment. Therefore, labels conveyed until the label can be detected by the sensor for printing alignment are discarded without being printed.

On the other hand, JP 2020-157522 A proposes a printer that eliminates label disposal even in the same situation.

In the printer described in JP 2020-157522 A, a sensor different from a sensor for printing alignment is provided downstream of a printing unit, and when a new label continuous body is set, a length of a label and a label gap are measured using the sensor disposed downstream of the printing unit.

Then, based on an actual measurement value, printing can be performed even on a label at a position that cannot be detected by the sensor provided upstream of the printing unit.

### SUMMARY OF INVENTION

In the printer described in JP 2020-157522 A, when the actual measurement value of the length of the label or the label spacing includes an error, the error may accumulate in a second label or a third label for which a print start position is determined based on the actual measurement value, and printing accuracy may be decreased.

Therefore, an object of the present invention is to provide a printer that prints on a label continuous body in which labels are arranged at a predetermined gap on a long liner sheet, and prints with high accuracy while eliminating label loss.

According to an aspect of the present invention, there is provided a printer for printing on a label continuous body in which labels are releasably attached to a long liner sheet at a predetermined spacing. The printer includes a conveyance unit configured to convey the label continuous body; a printing unit configured to print on each of the labels; a first detection unit disposed upstream of the printing unit in a conveyance direction and configured to detect each of the labels; a second detection unit disposed downstream of the printing unit in the conveyance direction and configured to detect each of the labels; and a controller configured to control the printing on the label and the conveyance of the label continuous body based on detection results of the first detection unit and the second detection unit. The controller is configured to perform the printing on the label by the printing unit while conveying the label continuous body, and measure, by the second detection unit, an arrangement length which is an spacing between a downstream end portion of the label on which the printing is performed and a downstream end portion of the label adjacent to the label on which the printing is performed, set a reference print start position of the label upstream of the printing unit based on the arrangement length, and correct the reference print start position using the arrangement length and an inter-unit distance between the printing unit and the first detection unit.

According to the above aspect, the controller that controls the printer performs the printing on the label by the printing unit, calculates, by the second detection unit, the arrangement length of the label on which the printing is performed, and sets, based on the calculated arrangement length, the reference print start position of the label that is disposed upstream of the printing unit and cannot be detected by the first detection unit.

Accordingly, even if the label cannot be detected by the first detection unit disposed upstream of the printing unit in the conveyance direction, the printing can be performed by determining the reference print start position.

The controller of the printer corrects the set reference print start position using the calculated arrangement length of the label and the inter-unit distance between the first detection unit and the second detection unit. Accordingly, in a printer for printing on a label continuous body in which labels are arranged at a predetermined gap on a long liner sheet, the printing can be performed with high accuracy.

### BRIEF DESCRIPTION OF DRAWINGS

FIG. 1 is a schematic configuration diagram of a printer according to an embodiment of the present invention.

FIG. 2 is a block diagram illustrating the printer according to the present embodiment.

FIG. 3 is a flowchart illustrating a method for controlling the printer by a controller.

FIG. 4 is a schematic diagram illustrating a process of detecting a downstream end portion of a first label of a newly set label continuous body.

FIG. 5 is a schematic diagram illustrating a process of calculating an arrangement length on a label in the present embodiment.

FIG. 6 is a schematic diagram illustrating a process of correcting a print start position in the present embodiment.

FIG. 7 is a schematic diagram illustrating the arrangement length and a reference print start position set by the controller based on a specific length and a specific coefficient.

FIG. 8 is a schematic diagram illustrating correction of the reference print start position by the controller.

FIG. 9 is a schematic diagram illustrating an example of a correction process of the reference print start position.

FIG. 10 is a schematic diagram illustrating an example of the correction process of the reference print start position.

### DESCRIPTION OF EMBODIMENTS

Hereinafter, an embodiment of the present invention will be described with reference to the accompanying drawings.

### Configuration of Printer

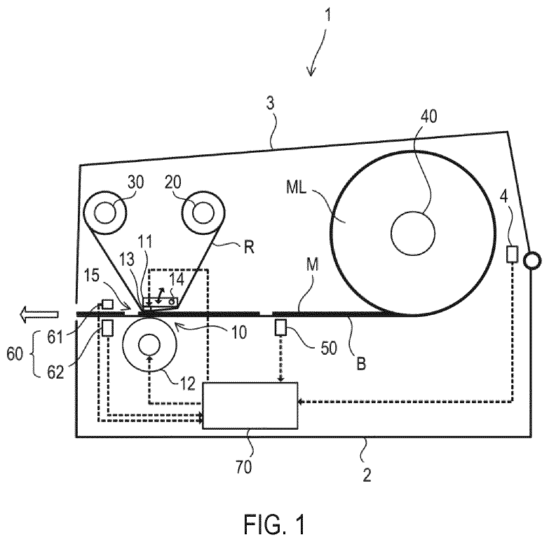

FIG. 1 is a schematic configuration diagram of a printer 1 according to an embodiment of the present invention.

The printer 1 is a thermal transfer printer that prints variable information such as a price, a bar code, other commodity information, and management information related to an article or a service on a print medium based on a medium issuance instruction, and performs printing by heating an ink ribbon R and transferring ink of the ink ribbon R to the print medium.

In the present embodiment, a label continuous body is used as the print medium. In the label continuous body (hereinafter, referred to as a continuous body ML), a plurality of labels M are successively releasably attached to a long liner sheet B at predetermined gaps, and the label continuous body is wound into a roll shape. In the present embodiment, in the continuous body ML, lengths of the labels M releasably attached to the long liner sheet B are all the same, and the predetermined gaps between the labels M are all the same.

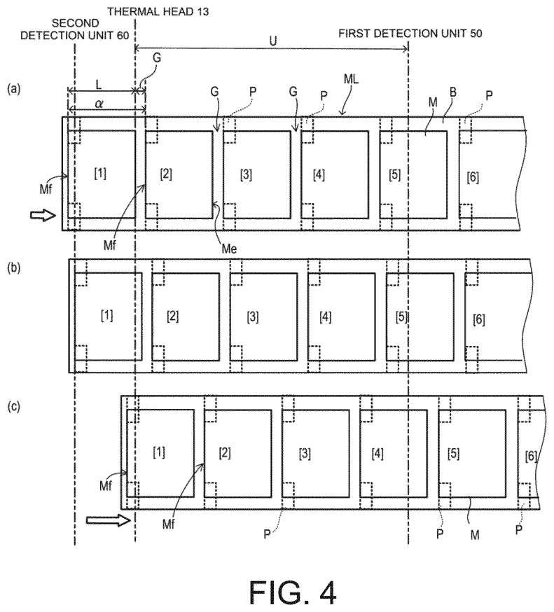

In the present embodiment, the predetermined gap between the labels M is expressed as a gap G. An spacing between a downstream end portion Mf of the label M and a downstream end portion Mf of the label M adjacent to the label M, that is, a total length of a length L of the label M in a conveyance direction and the gap G is expressed as an arrangement length α (see FIG. 4).

As shown in FIG. 1, the printer 1 includes a printing mechanism 10, a ribbon supply shaft 20, a ribbon wind-up shaft 30, and a medium supply shaft 40. The printer includes a first detection unit 50 that is disposed upstream of the printing mechanism 10 in the conveyance direction and detects the label M, a second detection unit 60 that is disposed downstream of the printing mechanism 10 in the conveyance direction and detects the label M, and a controller 70 serving as a control unit that controls each unit of the printer 1.

The above components are accommodated in a main body 2 and covered with a cover 3 attached to the main body 2 in an openable and closable manner. The cover 3 is provided with an opening/closing detection sensor 4 that detects opening/closing of the cover 3. As the opening/closing detection sensor 4, an optical sensor including a light emitting unit and a light receiving unit, a physical sensor in which a switch is turned on/off according to the opening/closing of the cover 3, or the like can be used.

The printing mechanism 10 includes a head unit 11 and a platen roller 12, and performs the printing on the label M and the conveyance of the continuous body ML and the ink ribbon R. That is, the printing mechanism 10 includes a printing unit that performs the printing on the label M and a conveyance unit that conveys the continuous body ML.

The head unit 11 holds a thermal head 13 with a heating element of the thermal head 13 exposed from a lower surface. The platen roller 12 is disposed immediately below the thermal head 13, and constitutes, together with the thermal head 13, a printing unit 15 that performs the printing on the label M.

The head unit 11 is supported by a support shaft 14 in a swingable manner in a direction of an arrow in FIG. 1. The head unit 11 can be moved between a head open position where the thermal head 13 is separated from the platen roller 12 and a head closed position where the thermal head 13 is in contact with the platen roller 12. In FIG. 1, the head unit 11 is at the head closed position.

The platen roller 12 is driven to rotate by a stepping motor (not shown), and can be driven to rotate forward or backward in accordance with an instruction signal from the controller 70.

The ribbon supply shaft 20 holds the ink ribbon R supplied to the printing unit 15 in a roll shape. The ink ribbon R supplied from the ribbon supply shaft 20 to the printing unit 15 is nipped between the thermal head 13 and the platen roller 12.

The medium supply shaft 40 holds the continuous body ML supplied to the printing unit 15 in a roll shape. The continuous body ML supplied from the medium supply shaft 40 to the printing unit 15 is nipped together with the ink ribbon R between the thermal head 13 and the platen roller 12.

The used ink ribbon R is wound up around an outer periphery of the ribbon wind-up shaft 30 when the ribbon wind-up shaft 30 is rotated due to gear connection with the stepping motor. When the head unit 11 is at the head open position, only the ink ribbon R can be sent in a winding-up direction by rotating the ribbon wind-up shaft 30.

When the heating element of the thermal head 13 is energized in a state where the label M and the ink ribbon R are nipped between the thermal head 13 and the platen roller 12, the ink of the ink ribbon R is transferred to the label M by the heat of the heating element, and the printing on the label M is performed. When the platen roller 12 is rotated forward by the stepping motor (not shown), the continuous body ML is conveyed to a downstream side (direction of a white arrow). Conveying the continuous body ML toward the downstream side in the conveyance direction is referred to as “forward feed”, and conveying the continuous body ML toward an upstream side in the conveyance direction, that is, in a direction opposite to the conveyance direction is referred to as “back feed”.

The first detection unit 50 includes a reflection sensor that detects position detection marks (hereinafter, referred to as eye marks P, see FIG. 4). The eye marks P are printed in advance at the same spacing as the attachment spacing of the labels M, on a surface of the liner sheet B opposite to a surface on which the labels M are attached.

When continuously printing and issuing the label M, the printer 1 can specify a print start position of the label M for the printing unit 15 based on a detection result of the first detection unit 50.

The second detection unit 60 includes a light emitting unit 61 that emits detection light and a light receiving unit 62 that receives the detection light, and constitutes a transmissive optical sensor. The second detection unit 60 outputs, to the controller 70, an output voltage based on the detection light received by the light receiving unit 62 via the continuous body ML.

The light emitting unit 61 has a multi-level light emission output of the detection light, for example, 128 levels in the present embodiment, and the light emission output can be adjusted under the control of the controller 70.

The light receiving unit 62 has multiple levels of light receiving sensitivity for receiving the detection light from the light emitting unit 61, and the light receiving sensitivity can be adjusted under the control of the controller 70. The light receiving unit 62 is disposed at a position facing the light emitting unit 61.

The controller 70 includes a microprocessor, a storage device such as a ROM or a RAM, an input/output interface, a bus connecting these components, and the like, which will be described later.

The controller 70 controls the conveyance of the continuous body ML and the printing on the label M based on the detection results of the first detection unit 50 and the second detection unit 60 according to a control program. Details of the control performed by the controller 70 will be described later.

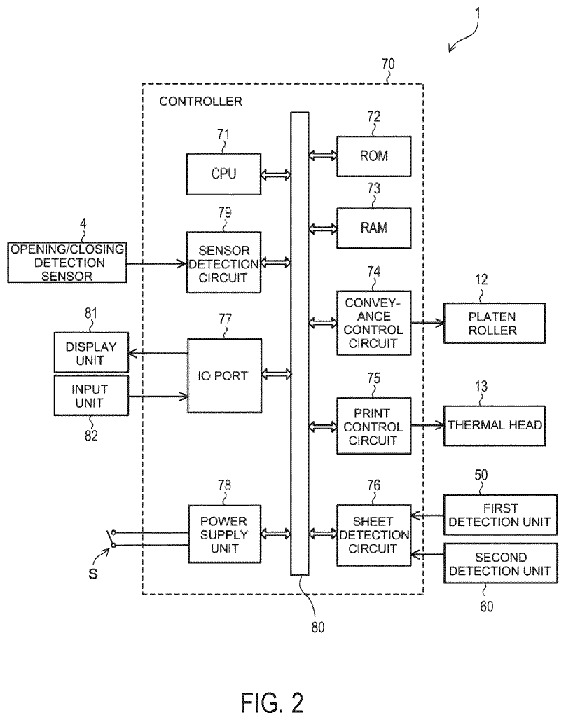

FIG. 2 is a block diagram illustrating the printer 1 according to the present embodiment.

The controller 70 includes a central processing unit (CPU) 71, a read only memory (ROM) 72, a random access memory (RAM) 73, a conveyance control circuit 74, a print control circuit 75, a sheet detection circuit 76, an IO port 77, a power supply unit 78, and a sensor detection circuit 79. These components are connected to each other via an internal bus 80, and are configured to be able to perform transmission and reception of various data.

By executing the above control program stored in the ROM 72, the CPU 71 integrally controls the entire controller 70, and causes each unit to execute necessary processes and control.

The ROM 72 stores a control program and the like that is read and executed by the CPU 71. The ROM 72 stores a control program for operating the first detection unit 50 and the second detection unit 60 to detect the label M, and performing the conveyance of the continuous body ML and the printing on the label M based on the detection results of the first detection unit 50 and the second detection unit 60.

In addition, the ROM 72 stores a program for performing the printing on the label M by the printing mechanism 10 while conveying the label continuous body ML, calculating the arrangement length α, which is the total length of the length L of the label M on which the printing is performed and the gap G, based on the detection result of the second detection unit 60, setting a reference print start position of the label M upstream of the printing mechanism 10 based on the arrangement length α, and correcting the reference print start position using the arrangement length α and an inter-unit distance U between the first detection unit 50 and the head unit 11 (thermal head 13).

The ROM 72 stores information related to a type (length, width, and the like) of the label M disposed on the label continuous body ML, and information such as a conveyance amount from the downstream end portion Mf of the label M to the print start position for each type of the label M. The information may be input to the printer 1 by a user when the label continuous body ML is set.

The RAM 73 stores various information necessary for a process executed by the CPU 71, print data necessary for printing, a printing format, registration information, and the like.

The conveyance control circuit 74 controls the stepping motor for driving the platen roller 12 according to an instruction signal from the CPU 71, and controls rotation/stop of the platen roller 12. Accordingly, the platen roller 12 is controlled to drive the “forward feed” or the “back feed” of the continuous body ML on a sheet conveyance path. The number of steps of the forward rotation or the reverse rotation of the stepping motor is counted.

The print control circuit 75 generates a print signal corresponding to print data such as characters, figures, and bar codes to be printed supplied from the CPU 71, and supplies the generated print signal to the thermal head 13. Accordingly, the printing is performed on the label M.

The sheet detection circuit 76 supplies information detected by the second detection unit 60 to the CPU 71. Alternatively, the sheet detection circuit 76 supplies information acquired by the first detection unit 50 to the CPU 71. Based on the information from the sheet detection circuit 76, the CPU 71 controls the conveyance of the continuous body ML and the ink ribbon R by the conveyance control circuit 74, and controls a timing of the printing by the thermal head 13 to execute the printing on the label M.

The IO port 77 is connected to a display unit 81 and an input unit 82, and outputs, to the display unit 81, display data supplied from the CPU 71. The IO port 77 sends an operation signal corresponding to an operation on the input unit 82 by the user to the CPU 71.

The display unit 81 includes, for example, a liquid crystal display. The input unit 82 includes a touch panel provided on the display unit 81, a button, a DIP-SW, and the like.

The power supply unit 78 monitors a pressing operation on a power supply switch S, and turns on/off a power supply of the printer 1 by switching between performing and stopping power supply to each unit based on an operation of the power supply switch S.

The sensor detection circuit 79 supplies information related to opening and closing of the cover 3 from the opening/closing detection sensor 4 to the CPU 71. The CPU 71 can start execution of an adjustment process of the output voltage in the second detection unit 60 upon receiving information from the sensor detection circuit 79 that a state is shifted from “open” to “close”.

The controller 70 shown in FIG. 2 may include a plurality of CPUs. The various control programs executed by the controller 70 may be stored in, for example, a non-transitory recording medium such as a CD-ROM or a semi-conductor medium, in addition to being stored in the ROM 72.

### Method for Controlling Printer

A method for controlling the printer 1 according to the present embodiment includes performing the printing on the label M by the printing mechanism 10, measuring by the second detection unit 60 the arrangement length α, which is the total length of the length of the label M on which the printing is performed and the gap G upstream of the label M, setting the reference print start position of the label M upstream of the printing mechanism 10 based on the arrangement length α, and correcting the reference print start position using the arrangement length α and the inter-unit distance U between the printing mechanism 10 and the first detection unit 50.

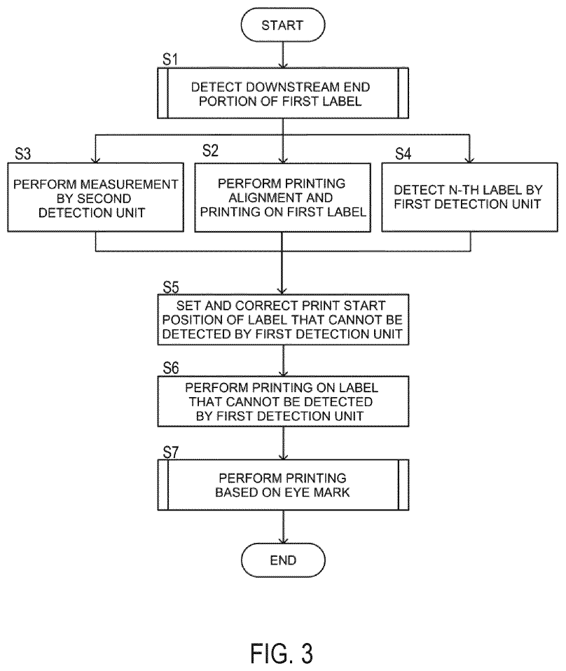

FIG. 3 is a flowchart illustrating the method for controlling the printer 1 by the controller 70. A process shown in FIG. 3 is executed, for example, when a new label continuous body ML is set in the printer 1.

FIG. 4 is a schematic diagram illustrating a process of detecting a downstream end portion Mf of a first label M[1] of the newly set label continuous body ML.

In the present embodiment, for example, as shown in FIG. 4, a case will be described in which the label continuous body ML is handled including three labels M existing between the label M[1] first detected by the second detection unit 60 and an n-th label (label M[5] in the present embodiment) first detected by the first detection unit 50.

FIG. 4 shows a positional relationship among the length L in the conveyance direction of the label M disposed on the label continuous body ML, a position of the first detection unit 50, a position of the second detection unit 60, and a position of the thermal head 13 in the printer 1. In order to make it easy to understand a change in a position of each of the labels M as the continuous body ML is conveyed, the labels M shown in FIG. 4 are provided with serial numbers ([1], [2], . . . ) representing an order in which the labels M are arranged.

FIG. 4 shows the downstream end portion Mf and an upstream end portion Me in the conveyance direction of the label M, the length L of the label M, and the gap G which is the gap between the labels M. The arrangement length α, which is the total length of the length L of the label M and the gap G upstream of the label M, and the inter-unit distance U between the head unit 11 (thermal head 13) and the first detection unit 50 are shown.

As shown in FIG. 4, the label continuous body ML includes the long liner sheet B and a plurality of labels M releasably attached on the liner sheet B. On a back surface side of the liner sheet B, the eye mark P for detecting the length L of the label M and the gap G is printed in advance at a position corresponding to a leading end downstream of the label M in the conveyance direction.

FIG. 4 shows a case where the length L of the label M in the conveyance direction is smaller than the inter-unit distance U (L<U).

A state (a) of FIG. 4 is a state in which the new label continuous body ML is set in the printer 1 by the user. In the present embodiment, the label continuous body ML is set in the printer 1 such that the end portion Mf of the label M in the label continuous body ML is roughly located at a position corresponding to the second detection unit 60.

A state (b) of FIG. 4 shows a state in which the downstream end portion Mf of the label M[1] is detected by the second detection unit 60. A state (c) of FIG. 4 shows a state in which the label continuous body ML is back fed such that a print start position of the label M[1] corresponds to the position of the thermal head 13.

When the user completes the setting of the label continuous body ML and moves the cover 3 to a closed position, the thermal head 13 is moved to the head closed position. When the controller 70 detects that the head unit 11 is moved to the head closed position, the controller 70 starts the process illustrated in FIG. 3.

In step S1, the controller 70 executes a detection process of the downstream end portion Mf of the label M[1].

In the detection process of the downstream end portion Mf, the controller 70 back feeds the label continuous body ML until the downstream end portion Mf of the label M[1] is detected (from the state (a) to the state (b) in FIG. 4).

When the downstream end portion Mf of the label M[1] is detected, the controller 70 back feeds the label M[1] based on a type of the label M input in advance such that the print start position on the label M corresponds to the position of the thermal head 13 (from the state (b) to the state (c) in FIG. 4).

Subsequently, the controller 70 executes a process of step S2, a process of step S3, and a process of step S4.

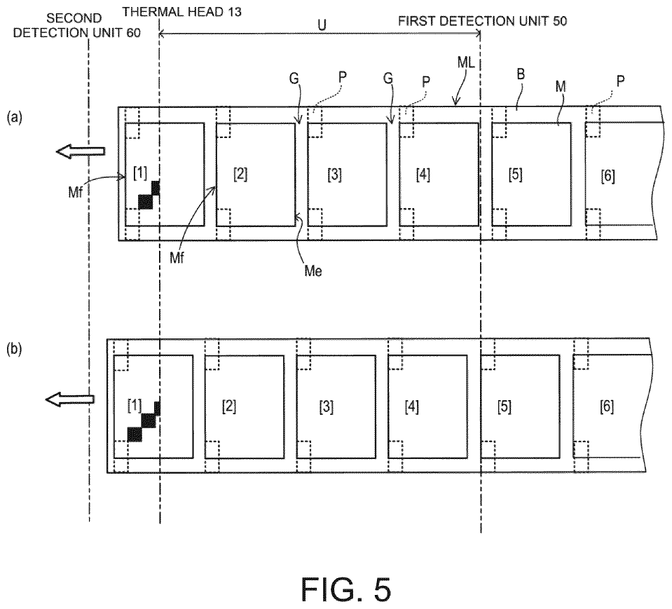

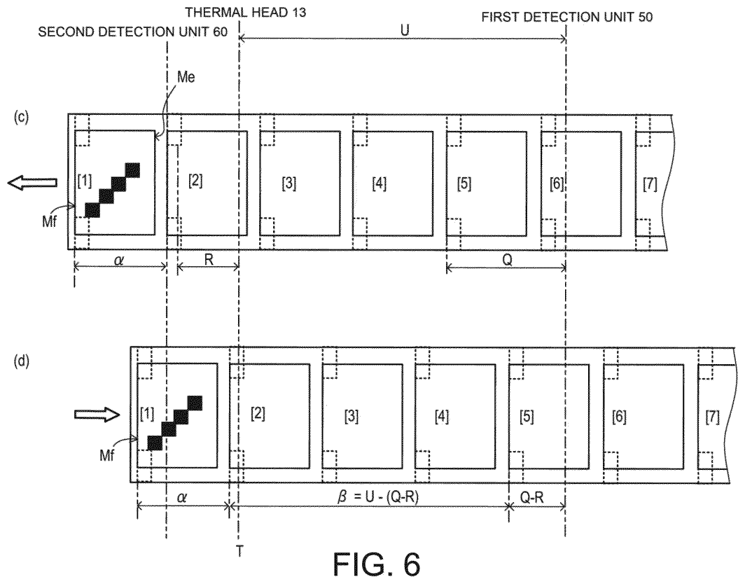

FIG. 5 is a schematic diagram illustrating a process of calculating the arrangement length α on the label M. FIG. 6 is a schematic diagram illustrating a process of correcting the print start position.

In step S2, the controller 70 causes the head unit 11 (thermal head 13) to start the printing on the label M[1] (state (a) in FIG. 5).

The controller 70 measures the label M[1] by the second detection unit 60 in step S3 while executing step S2.

The controller 70 measures a change in a detection voltage based on the detection light received by the light receiving unit 62 every time the platen roller 12 is forward fed by one step while printing on the label M[1].

When the downstream end portion Mf of the label M[1] which is being printed while being conveyed, approaches a transmission position of the detection light, an amount of detection light received by the light receiving unit 62 is decreased. After an upstream end portion Me of the label M[1] passes through the transmission position of the detection light, the detection light is transmitted only through the liner sheet B, and thus the amount of light received by the light receiving unit 62 is increased. Accordingly, the presence or absence of the label M on the liner sheet B can be detected.

The controller 70 conveys the label continuous body ML even after the printing on the label M[1] is completed (state (c) in FIG. 6). That is, the controller 70 conveys the label continuous body ML until a downstream end portion Mf of a label M[2] is detected after the transmission position of the detection light passes through the gap G.

While executing steps S2 and S3, the controller 70 executes a process of detecting a downstream end portion Mf of a label M[n] by the first detection unit 50 in step S4. The label M[n] is the label M from which the eye mark P is first detected by the first detection unit 50, and is the fifth label M[5] in the present embodiment (see states (a) and (b) of FIG. 5).

In the present embodiment, the setting is such that the printing on the label M[2] is not performed during conveyance after the printing on the label M[1] is completed.

After the detection of the upstream end portion Me of the label M[1] and the detection of the gap G are completed, the controller 70 performs the forward feed until the downstream end portion Mf of the label M[2] is detected (state (c) in FIG. 6).

When the downstream end portion Mf of the label M[2] is detected (state (c) in FIG. 6), the controller 70 proceeds to step S5.

In step S5, the controller 70 executes a process of setting a reference print start position for a label M on which the printing is not performed and a process of correcting the set reference print start position, by using the arrangement length α obtained based on measurement results in steps S2 and S4 and the inter-unit distance U. In the present embodiment, print start positions of the label M[2], the label M[3], and the label M[4] are corrected.

Subsequently, in step S6, the controller 70 performs the printing from the label M[2] to the label M[4] based on the corrected print start position obtained in step S5.

When the printing on the second to fourth labels M[2] to M[4] on which the eye mark P cannot be detected by the first detection unit 50 is completed, the controller 70 performs the printing based on the eye mark P on the label M[5] and subsequent labels on which the eye mark P can be detected by the first detection unit 50 in step S7.

### Setting and Correction Processes of Reference Print Start Position

Next, the setting and correction processes of the reference print start position executed by the controller 70 in step S5 will be described.

The controller 70 measures the arrangement length α including the length L of the label M[1] and the gap G based on the detection result of the upstream end portion Me of the label M[1] and the downstream end portion Mf of the label M[2] by the second detection unit 60.

In the present embodiment, the controller 70 also detects a downstream end portion Mf of the label M[n] (fifth label M[5] in the present embodiment) by the first detection unit 50 while measuring the arrangement length α by the second detection unit 60.

Based on the measured arrangement length α, the controller 70 executes the setting process of the reference print start position of each of the labels on which the printing is not performed (label M[2] to label M[4] in the present embodiment), and executes the correction process of the set reference print start position.

The controller 70 calculates a conveyance distance (Q) conveyed from when the downstream end portion Mf of the fifth label M[5] is detected by the first detection unit 50 to when the downstream end portion Mf of the label M[2] is detected by the second detection unit 60 (see FIG. 6). Then, the controller 70 corrects the reference print start positions of the label M[2] to the label M[4] based on the inter-unit distance U, the measured arrangement length α, and the calculated conveyance distance (Q).

Specifically, when the downstream end portion Mf of the label M[2] is detected by the second detection unit 60, the controller 70 stops the forward feed (state (c) of FIG. 6).

Next, for printing on the label M[2], the controller 70 back feeds the label continuous body ML until the print start position of the label M[2] corresponds to the thermal head 13 (state (d) of FIG. 6).

A value obtained by subtracting a back feed distance (R) until the print start position of the second label M[2] corresponds to the thermal head 13 from the conveyance distance (Q) conveyed from when the downstream end portion Mf of the label M[5] is detected by the first detection unit 50 to when the downstream end portion of the label M[2] is detected by the second detection unit 60 is expressed as (Q−R).

At this time, a specific length β which is a length from the downstream end portion Mf of the label M[2] to the downstream end portion Mf of the fifth label M[5] is a sum of the arrangement lengths α of the three labels M from the label M[2] to the label M[4] (see FIG. 6).

The specific length β is obtained by subtracting the value (Q−R) from the inter-unit distance U between the position of the head unit 11 (thermal head 13) and the first detection unit 50.

$$That is , β = U - ( Q - R ) .$$

The controller 70 sets the reference print start position for the label M on which the eye mark P cannot be detected by the first detection unit 50, using the arrangement length α measured at the time of printing on the first label M[1] and the specific length β.

The controller 70 calculates a predetermined integer X such that an absolute value of a value is smallest that is obtained by subtracting a value obtained by multiplying the arrangement length α by the integer X from the specific length β, and sets the integer X as a specific coefficient X. Then, the controller 70 sets the specific coefficient X as the number of labels existing between the label M[1] and the label M[n].

In the present embodiment, the controller 70 calculates |β−(α×1)|, |β−(α×2)|, . . . , |β−(α×n)|, so as to search for the specific coefficient X. In the examples shown in FIGS. 4 to 6, the specific coefficient (integer X) is set to be 3.

In a quotient and a remainder obtained by dividing the specific length β by the specific coefficient X, the controller 70 sets the quotient as an arrangement length α1 of each of the labels M existing between the label M[1] and the label M[n].

The controller 70 sets a reference print start position T for each of the labels M between the label M[1] and the label M[n] based on the newly set arrangement length α1.

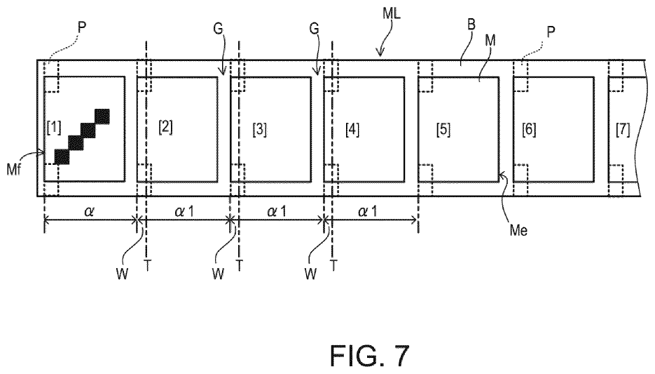

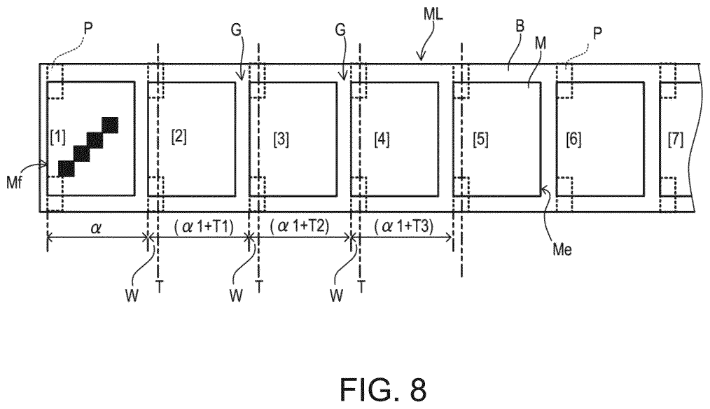

FIG. 7 is a schematic diagram illustrating the arrangement length α and the reference print start position T set by the controller 70 based on the specific length β and the specific coefficient X. FIG. 8 is a schematic diagram illustrating correction of the reference print start position T by the controller 70.

As shown in FIG. 7, in the present embodiment, the controller 70 assumes, for example, the arrangement lengths α1 of the label M[2] to the label M[4]. The controller 70 sets the reference print start position T at a position shifted by a length W from a position corresponding to the downstream end portion Mf of each of the labels M set for each of the arrangement lengths α1.

Subsequently, the controller 70 executes a correction process of the set reference print start position T.

The controller 70 corrects the reference print start position T using a remainder R obtained by dividing the specific length β by the specific coefficient X as a correction value.

When the remainder R when the specific length β is divided by the specific coefficient X is 0, the controller 70 sets the correction value to be 0. That is, the controller 70 performs the printing by using the reference print start position T shown in FIG. 7 as it is.

On the other hand, when there is a remainder R when the specific length β is divided by the specific coefficient X, the controller 70 distributes the remainder R to each of the labels M existing between the label M[1] and the label M[n] as T1, T2, T3, and T4, and adds T1, T2, T3, and T4 to the respective arrangement lengths α1.

In the example shown in FIG. 8, the label M[2], the label M[3], and the label M[4] existing between the label M[1] and the label M[5] are distributed as T1, T2, and T3, and T1, T2, and T3 is added to the respective arrangement lengths α1, and new arrangement lengths (α1+T1), (α1+T2), and (α1+T3) are set.

The controller 70 may add the remainder R to only the arrangement length α1 of any of the labels M existing between the label M[1] and the label M[n].

Next, the correction process of the reference print start position will be described by showing specific numerical values as an example.

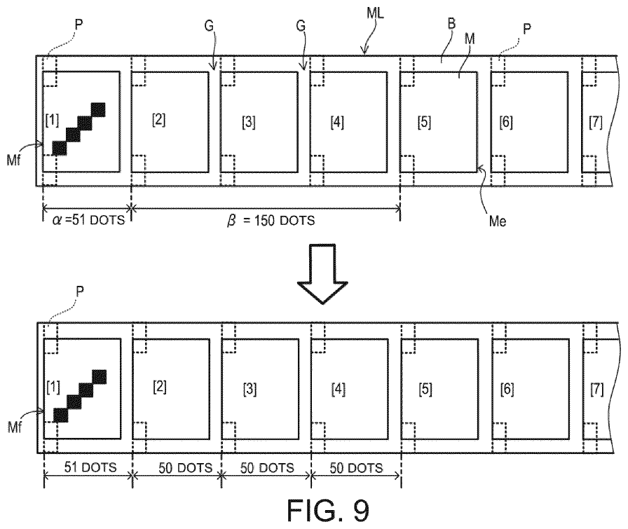

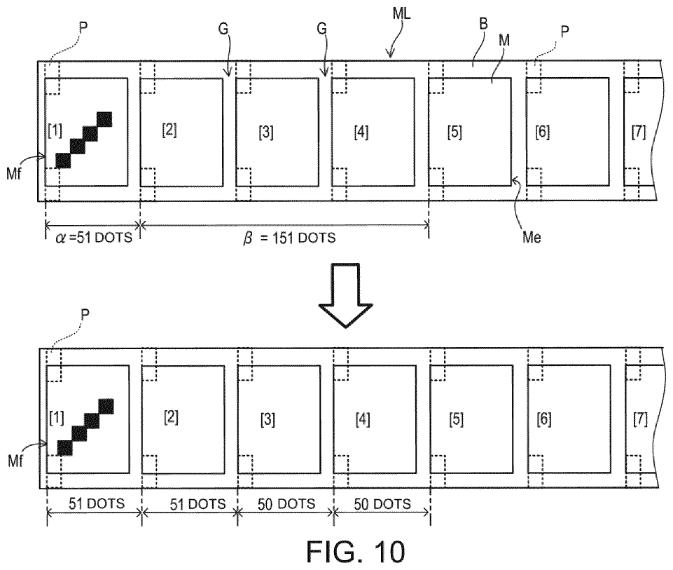

FIGS. 9 and 10 are schematic diagrams illustrating the correction process of the reference print start position. In FIGS. 9 and 10, the “length” is expressed by a “dot”.

For example, as shown in FIG. 9, when the arrangement length α of the actually measured label M[1] is 51 dots and the specific length β is 150 dots, the controller 70 calculates the integer X such that an absolute value of a value is smallest that is obtained by subtracting a value obtained by multiplying the arrangement length α=51 by the integer X from the specific length β. That is,

$$if X = 2 , \vert 150 - ( 51 \times 2 ) \vert = 48 ,$$

$$If X = 3 , \vert 150 - ( 51 \times 3 ) \vert = 3.$$

Therefore, the controller 70 sets the specific coefficient (integer X) to be 3. Then, the controller 70 sets 150/3=50, which is a value obtained by dividing the specific length β (B=150) by the specific coefficient X (X=3), as the arrangement length α1.

Since the remainder R=0, the correction value is zero. Therefore, the controller 70 sets the reference print start position based on the arrangement length α1=50 dots.

On the other hand, as shown in FIG. 10, when the arrangement length α of the actually measured label M[1] is 51 dots and the specific length β is 151 dots, the controller 70 calculates the integer X such that an absolute value of a value is smallest that is obtained by subtracting a value obtained by multiplying the arrangement length α=51 by the integer X from the specific length β. That is,

$$if X = 2 , \vert 151 - ( 51 \times 2 ) \vert = 49 ,$$

$$If X = 3 , \vert 151 - ( 51 \times 3 ) \vert = 2.$$

Therefore, the controller 70 sets the specific coefficient (integer X) to be 3. Then, the controller 70 performs an operation of dividing the specific length β (B=151) by the specific coefficient X (X=3) to calculate a quotient and a remainder. Since 151/3=50 remainder 1, the controller 70 sets the arrangement length α1 of the label M[2] to be 50+1 using the remainder 1 as the correction value.

Since the remainder is 1, there is no correction value assigned to the label M[3] and the label M[4] in this example.

As described above, the controller 70 can calculate the reference print start position using the inter-unit distance U and the measured arrangement length α, and further correct the reference print start position.

### Functions and Effects

In a printer in the related art, for example, when a relationship between a length L of a label and a distance D between a thermal head and a detection unit for detecting an eye mark is L<D, a print start position cannot be set for a label on which an eye mark p cannot be detected. Therefore, when a label continuous body is set, there is a problem that printing cannot be performed on some labels M located downstream of a first detection unit.

On the other hand, according to the printer 1 of the present embodiment, while the printing is performed on the label M[1], the downstream end portion Mf of the label M[2] is measured from the downstream end portion Mf of the label M[1] by the second detection unit 60.

Accordingly, when the label continuous body ML is set in the printer 1, the reference print start position can be set even for the label M[2] to the label M[4] on which the eye mark P cannot be detected because the label M[2] to the label M[4] are located downstream of the first detection unit 50, and the printing can be performed.

Further, according to the printer 1 of the present embodiment, even when an error caused by actual measurement is included in the calculated arrangement length α, the error can be corrected using the arrangement length α and the inter-unit distance U.

Accordingly, it is possible to strictly set the print start position determined based on a numerical value obtained by the actual measurement, and it is possible to improve printing accuracy.

Therefore, in the printer 1 that prints on the label continuous body ML in which the labels M are arranged, label loss can be eliminated, and the printing can be performed with high accuracy.

### Other Embodiments

Although the embodiment of the present invention has been described above, the above embodiment is merely an application example of the present invention and is not intended to limit the technical scope of the present invention to the specific configuration of the above embodiment.

The eye mark P only needs to be an index that can detect the arrangement length α including the length L of the label M and the gap G, and the eye mark P may be printed at a position other than the position corresponding to the leading end downstream of the label M in the conveyance direction.

In the present embodiment, the printer 1 using ink ribbon transfer by the thermal head 13 has been described, but a thermal transfer printer may be used in which the label M is thermal paper and the thermal head 13 applies heat to print on the label M.

The flowchart shown in FIG. 3 is a process assuming that the new label continuous body ML is set in the printer 1 such that the first label M[1] corresponds to the second detection unit 60 as shown in (a) of FIG. 4.

On the other hand, when the head unit 11 is set at the head closed position, the controller 70 may execute the process of detecting the downstream end portion Mf of the label M[1] by performing the forward feed from a state where the gap G between the labels M is set at the position corresponding to the second detection unit 60.

In the actual label continuous body ML, the gap G between the labels M is often set to be significantly shorter than the length L of the label M in the conveyance direction, and thus it is easier for the user to set the label M to the position corresponding to the second detection unit 60.

In the present embodiment, when the new label continuous body ML is set, the user may input a size of the label M, or the length L of the label M[1] may be measured by the second detection unit 60. In this case, it is possible to measure the length L of the label M in the conveyance direction using a difference between an amount of transmitted light detected by the second detection unit 60 at a position where the liner sheet B and the label M overlap and an amount of transmitted light transmitted only through the liner sheet B.

In a case of executing a measurement process only for actually measuring the length L of the label M[1] before the printing, the controller 70 measures the length L of the first label M[1] and then back feeds the label M[1] based on the actually measured length L of the label M such that the position of the thermal head 13 corresponds to the print start position of the label M.

In this case, it takes time to execute the measurement process of the length L of the label M[1] before the printing on the label M[1] is started, but an operation input by the user can be omitted.

In the present embodiment, even if an error occurs in a measured value of the label M[1], the error is minute with respect to the length L of the label M and a size of the gap G. Therefore, a threshold value may be set for the remainder R, and the controller 70 may determine that an error occurs when the remainder R is equal to or greater than the threshold value.

In the present embodiment, various programs used in the printer 1 may be stored in, for example, a non-transitory recording medium such as a CD-ROM.

The present application claims priority under Japanese Patent Application No. 2021-194630 filed to the Japan Patent Office on Nov. 30, 2021, and the entire content of this application is incorporated herein by reference.

1.-9. (canceled)

10. A printer for printing on a label continuous body in which labels are releasably attached to a long liner sheet at a predetermined spacing, the printer comprising:
a conveyance unit configured to convey the label continuous body;
a printing unit configured to print on each of the labels;
a first detection unit disposed upstream of the printing unit in a conveyance direction and configured to detect each of the labels;
a second detection unit disposed downstream of the printing unit in the conveyance direction and configured to detect each of the labels; and
a controller configured to control the printing on the label and the conveyance of the label continuous body based on detection results of the first detection unit and the second detection unit, wherein:
the controller is configured to:
perform the printing on the label by the printing unit while conveying the label continuous body, and measure, by the second detection unit, an arrangement length which is a spacing between a downstream end portion of the label on which the printing is performed and a downstream end portion of the label adjacent to the label on which the printing is performed,
set a reference print start position of the label upstream of the printing unit based on the arrangement length, and
correct the reference print start position using the arrangement length and an inter-unit distance between the printing unit and the first detection unit.

11. The printer according to claim 10, wherein:
the controller is configured to, in the measurement of the arrangement length, detect, by the second detection unit, a downstream end portion of a first label on which the printing is performed and detect a downstream end portion of a second label by the second detection unit, and
the controller is configured to:
detect a downstream end portion of an n-th label by the first detection unit,
set, based on the arrangement length, a reference print start position of each label from a label on which the printing is not performed to an (n−1)-th label located downstream of the n-th label,
calculate a conveyance distance conveyed from when the downstream end portion of the n-th label is detected by the first detection unit to when the downstream end portion of the second label is detected by the second detection unit, and
correct, based on the inter-unit distance, the arrangement length, and the conveyance distance, the reference print start position of at least one of the labels from the label on which the printing is not performed to the (n−1)-th label.

12. The printer according to claim 11, wherein
the controller is configured to:
further convey the label continuous body after the printing on the first label is completed, and
convey, when the downstream end portion of the second label is detected by the second detection unit, the label continuous body in a direction opposite to the conveyance direction such that a print start position on the second label corresponds to the printing unit for printing on the second label.

13. The printer according to claim 11, wherein:
the controller is configured to:
calculate an integer X such that an absolute value of a value is smallest, the value being obtained by subtracting a value obtained by multiplying the arrangement length by the integer X from a specific length from a downstream end portion of the label on which the printing is not performed to the downstream end portion of the n-th label,
set the calculated integer X as a specific coefficient, and
set the specific coefficient as the number of labels existing between the first label and the n-th label.

14. The printer according to claim 13, wherein:
the controller is configured to:
set the reference print start position by using, as the arrangement length of each of the labels existing between the first label and the n-th label, a quotient obtained by dividing the specific length by the specific coefficient, and
correct the reference print start position by using a remainder as a correction value.

15. The printer according to claim 14, wherein:
the controller is configured to:
set the correction value to be 0 when a remainder obtained by dividing the specific length by the specific coefficient is 0, and
add the remainder to the arrangement length of any of the labels existing between the first label and the n-th label.

16. The printer according to claim 14, wherein:
the controller is configured to distribute a remainder obtained by dividing the specific length by the specific coefficient to each of the labels existing between the first label and the n-th label and add the remainder to the arrangement length of each of the labels.

17. The printer according to claim 12, wherein:
the controller is configured to:
calculate an integer X such that an absolute value of a value is smallest, the value being obtained by subtracting a value obtained by multiplying the arrangement length by the integer X from a specific length from a downstream end portion of the label on which the printing is not performed to the downstream end portion of the n-th label,
set the calculated integer X as a specific coefficient, and
set the specific coefficient as the number of labels existing between the first label and the n-th label.

18. The printer according to claim 17, wherein:
the controller is configured to:
set the reference print start position by using, as the arrangement length of each of the labels existing between the first label and the n-th label, a quotient obtained by dividing the specific length by the specific coefficient, and
correct the reference print start position by using a remainder as a correction value.

19. The printer according to claim 18, wherein:
the controller is configured to:
set the correction value to be 0 when a remainder obtained by dividing the specific length by the specific coefficient is 0, and
add the remainder to the arrangement length of any of the labels existing between the first label and the n-th label.

20. The printer according to claim 18, wherein:
the controller is configured to distribute a remainder obtained by dividing the specific length by the specific coefficient to each of the labels existing between the first label and the n-th label and add the remainder to the arrangement length of each of the labels.

21. A printer control method for controlling a printer that comprises a printing unit configured to print on a label continuous body in which labels are releasably attached to a long liner sheet at a predetermined spacing, a conveyance unit configured to convey the label continuous body, a first detection unit disposed upstream of the printing unit in a conveyance direction and configured to detect each of the labels, and a second detection unit disposed downstream of the printing unit in the conveyance direction and configured to detect each of the labels, the printer control method being for controlling the printing on the label and the conveyance of the label continuous body based on detection results of the first detection unit and the second detection unit, the printer control method comprising:
performing the printing on the label by the printing unit while conveying the label continuous body, and measuring, by the second detection unit, an arrangement length which is an spacing between a downstream end portion of the label on which the printing is performed and a downstream end portion of the label adjacent to the label on which the printing is performed;
setting a reference print start position of the label upstream of the printing unit based on the arrangement length; and
correcting the reference print start position using the arrangement length and an inter-unit distance between the printing unit and the first detection unit.

22. A non-transitory computer-readable recording medium including a program configured to cause a computer of a printer that comprises a printing unit configured to print on a label continuous body in which labels are releasably attached to a long liner sheet at a predetermined spacing, a conveyance unit configured to convey the label continuous body,
a first detection unit disposed upstream of the printing unit in a conveyance direction and configured to detect each of the labels, and a second detection unit disposed downstream of the printing unit in the conveyance direction and configured to detect each of the labels, the program being for controlling the printing on the label and the conveyance of the label continuous body based on detection results of the first detection unit and the second detection unit, the program causing the computer to:
perform the printing on the label by the printing unit while conveying the label continuous body, and measure, by the second detection unit, an arrangement length which is an spacing between a downstream end portion of the label on which the printing is performed and a downstream end portion of the label adjacent to the label on which the printing is performed;
set a reference print start position of the label upstream of the printing unit based on the arrangement length; and
correct the reference print start position using the arrangement length and an inter-unit distance between the printing unit and the first detection unit.
